(19) United States
(12) Patent Application Publication
(10) Pub. No.: US 2018/0347269 A1
(43) Pub. Date: Dec. 6, 2018

(54) WINDING DEVICE FOR A BLIND

(71) Applicant: J. PAXTON ENTERPRISES, INC., Kaohsiung City (TW)

(72) Inventor: Teh-Hao WANG, Kaohsiung City (TW)

(73) Assignee: J. PAXTON ENTERPRISES, INC., Kaohsiung City (TW)

(21) Appl. No.: 15/609,399

(22) Filed: May 31, 2017

(51) Int. Cl. E06B 9/322; E06B 9/78; E06B 9/60

(52) U.S. Cl. CPC E06B 9/322; E06B 2009/785; E06B 9/60; E06B 9/78

(57) ABSTRACT

A winding device for a blind includes two pivot seats, two limiting members respectively pivoted to the pivot seats, a spring member having first and second end portions respectively connected to the limiting members, an outer tube sleeved on the spring member, and two tubular sleeves connected between one of the limiting members and the outer tube. When the tubular sleeves are driven to rotate by a blind body of the blind, one of the tubular sleeves drives one limiting member to rotate synchronously, but the other tubular sleeve cannot drive the other limiting member to rotate therealong, such that the first and second end portions of the spring member are twisted to provide a resilient restoring force for balancing and positioning the blind body.

### FIELD

The disclosure relates to a winding device, more particularly to a winding device for a blind.

### BACKGROUND

Referring to FIGS. 1 and 2, a blind suspension system, as disclosed in Taiwanese Patent No. 1342355, includes a blind 11 fixed by two lift cords 10, a headrail 12 for extension of the lift cords 10 therethrough, two pivot seats 13 spacedly disposed on the headrail 12, two drums 14 (only one is shown) respectively pivoted to the pivot seats 13 for winding the lift cords 10 thereon, a bottom rail 15 disposed on a bottom end of the blind 11, and two spring members 16 (only one is shown) providing biasing forces to the drums 14. Each spring member 16 has one end fixed to one of the pivot seats 13, and the other end fixed to a corresponding one of the drums 14. When the blind 11 is pulled, the lift cords 10 will respectively drive the drums 14 to rotate and pull the spring members 16. The spring members 16, in turn, will generate restoring forces and exert action forces on the respective drums 14. When the action forces of the spring members 16 are balanced with the bottom rail 15, the blind 11 is positioned. Although the blind suspension system can achieve the effect of positioning the blind 11, the spring members 16 are easily deformed so that the service life thereof is reduced. Further, each drum 14 must correspond in position with an exit point of the respective lift cord 10 as the latter extends through the headrail 12, so that the disposition thereof is rather difficult.

Referring to FIGS. 3 and 4, a blind body drive structure, as disclosed in Taiwanese Patent No. M535733, includes upper and lower beams 21, 22, a blind body 23 disposed between the upper and lower beams 21, 22, two cord winding devices 24 spacedly disposed on the upper beam 21, a movable seat 25 movable relative to the cord winding devices 24 and slidable along a length direction of the upper beam 21, an elastic member 26 having two ends respectively connected to the movable seat 25 and one of the cord winding devices 24, and a lift cord 27 looped over the movable seat 25 and the other cord winding device 24 and fixed to the lower beam 22. When the blind body 23 is pulled downward by a user, the movable seat 25 is driven to slide by the lift cord 27, and the elastic member 26 is stretched to provide a restoring force to the movable seat 25. Two sides of the movable seat 25 are respectively pulled by the elastic member 26 and the lift cord 27. When the forces between the two are balance, the blind body 23 is positioned at an appropriate position. However, the assembly of the blind body drive structure is complicated. Further, a substantial space must be reserved in the upper beam 21 for sliding movement of the movable seat 25 therein.

### SUMMARY

Therefore, an object of the present disclosure is to provide a winding device for a blind that can alleviate at least one of the drawbacks of the prior arts.

According to this disclosure, a winding device for a blind includes a frame unit, and inner and outer pivot units. The frame unit includes a frame extending along an axial direction, and two pivot seats disposed on the frame and spaced apart from each other along the axial direction. The inner pivot unit includes two limiting members connected pivotally and respectively to the pivot seats, an inner tube connected between the limiting members, and a spring member sleeved on the inner tube and having first and second end portions opposite to each other along the axial direction and respectively connected to the limiting members. The outer pivot unit includes an outer tube sleeved on the spring member and having two opposite ends, and two tubular sleeves each of which is connected between one of the ends of the outer tube and a corresponding one of the limiting members. The tubular sleeves are configured to be driven by a blind body of the blind. When the blind body is moved in an up-down direction, the tubular sleeves are driven by the blind body to rotate, and one of the tubular sleeves drives one of the limiting members to rotate synchronously, but the other one of the tubular sleeves cannot drive the other one of the limiting members to rotate therealong, such that the first and second end portions of the spring member are twisted to provide a resilient restoring force for balancing and positioning the blind body.

### BRIEF DESCRIPTION OF THE DRAWINGS

Other features and advantages of the disclosure will become apparent in the following detailed description of the embodiments with reference to the accompanying drawings, of which:

FIG. 1 is a schematic view of a blind incorporating a blind suspension system disclosed in Taiwanese Patent No. 1342355;

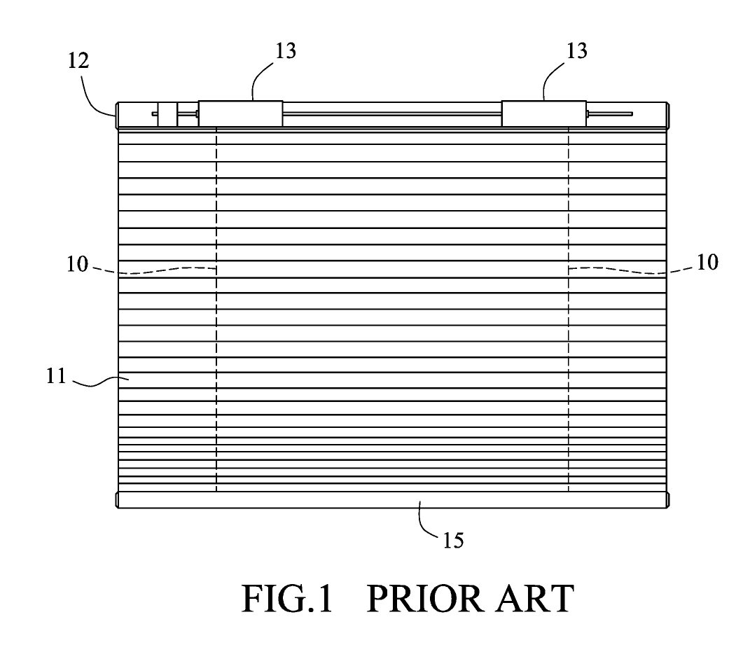

FIG. 2 is an exploded perspective view of a portion of the blind suspension system of FIG. 1;

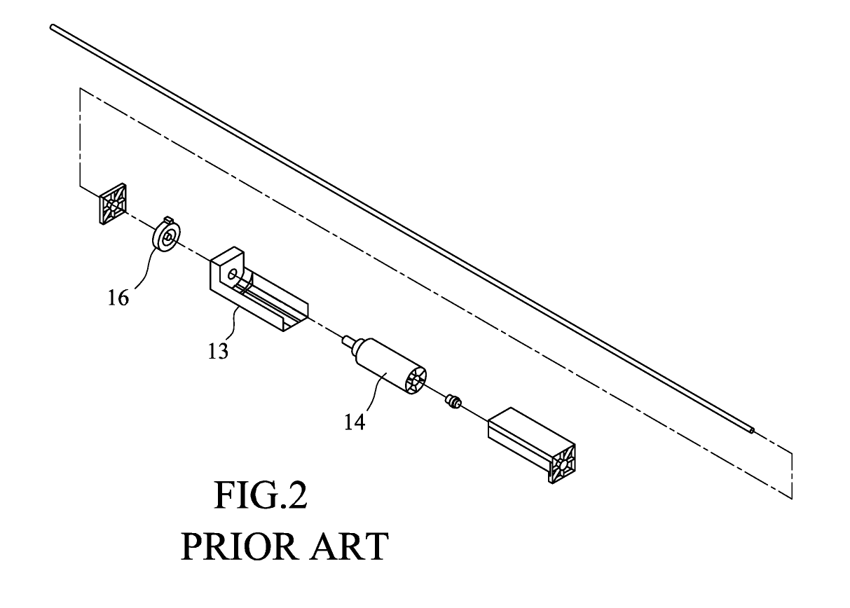

FIG. 3 is a perspective view of a blind body drive structure disclosed in Taiwanese Patent No. M535733;

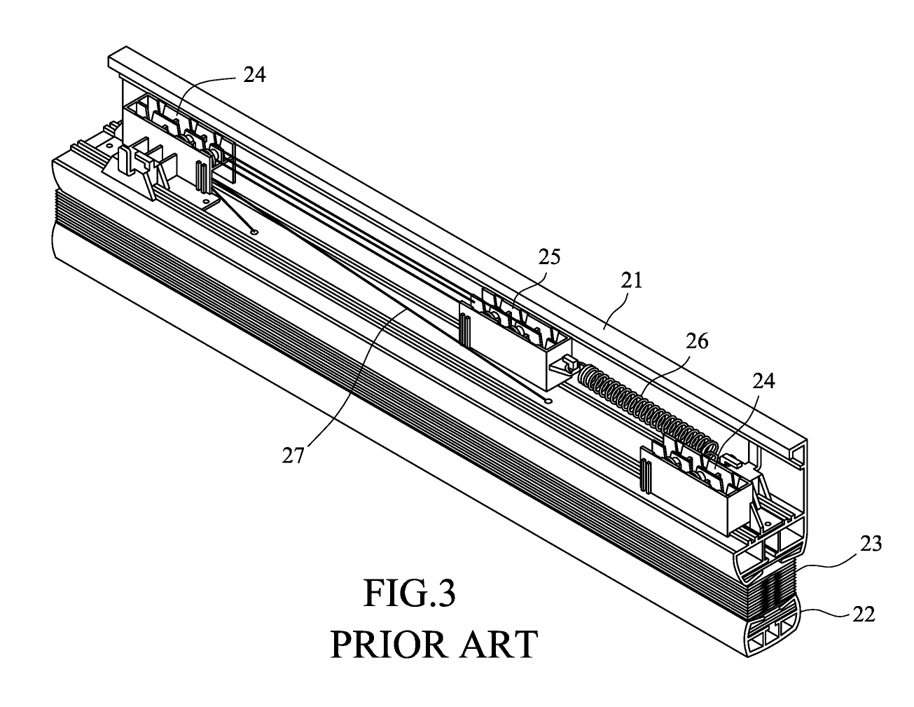

FIG. 4 is an exploded perspective view of the blind body drive structure of FIG. 3;

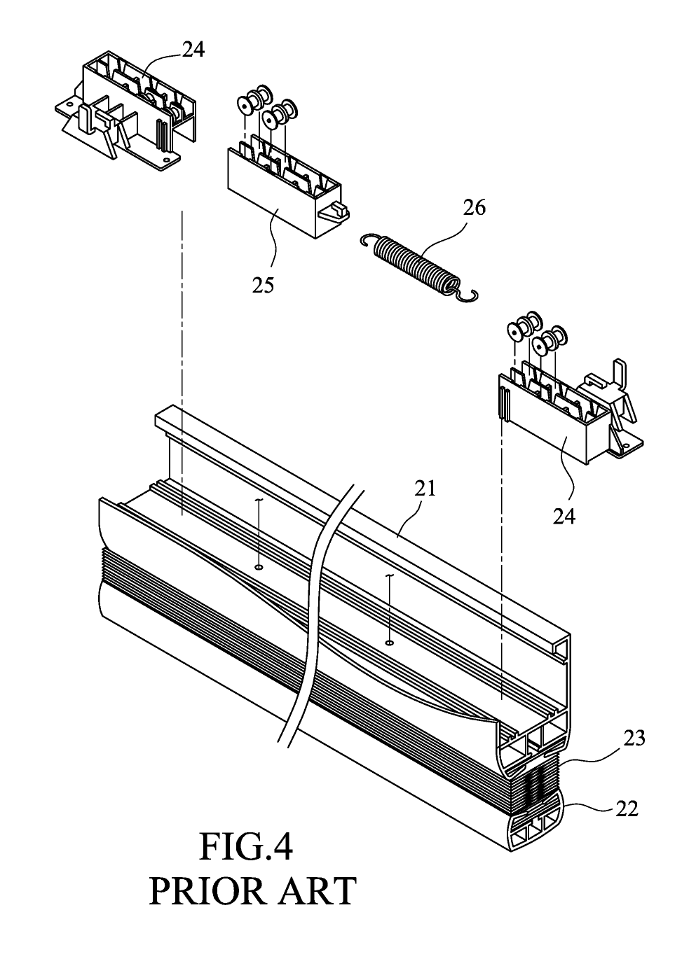

FIG. 5 is a perspective view of a winding device according to the first embodiment of the present disclosure;

FIG. 6 is an exploded perspective view of the first embodiment;

FIG. 7 is a perspective view of a limiting member of the first embodiment;

FIG. 8 is a sectional side view of the first embodiment;

FIG. 9 is a sectional top view of the first embodiment;

FIG. 10 is a view similar to FIG. 6, but illustrating another way of inserting a lift cord; and

FIG. 11 is a perspective view of a winding device according to the second embodiment of the present disclosure.

### DETAILED DESCRIPTION

Before the present disclosure is described in greater detail, it should be noted herein that like elements are denoted by the same reference numerals throughout the disclosure.

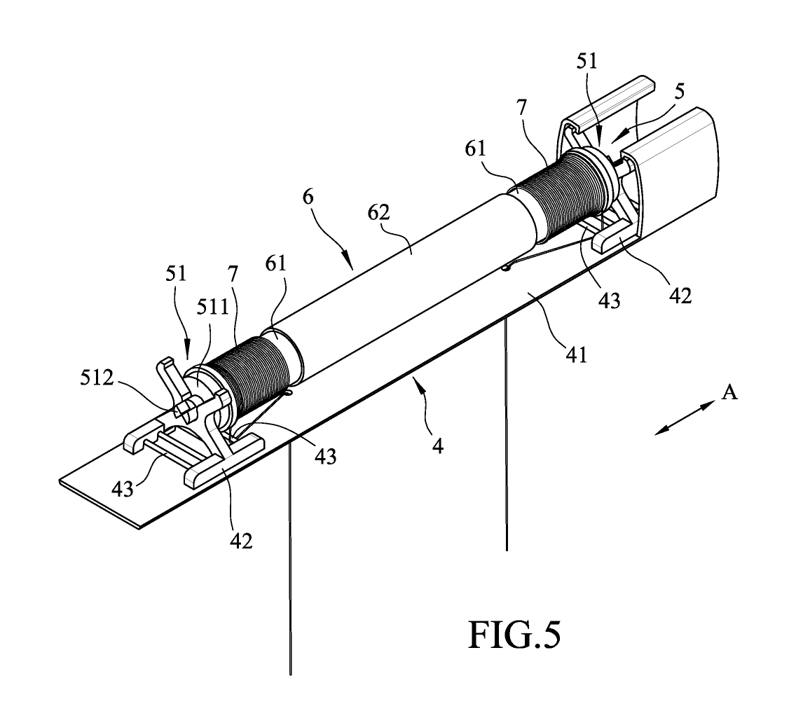

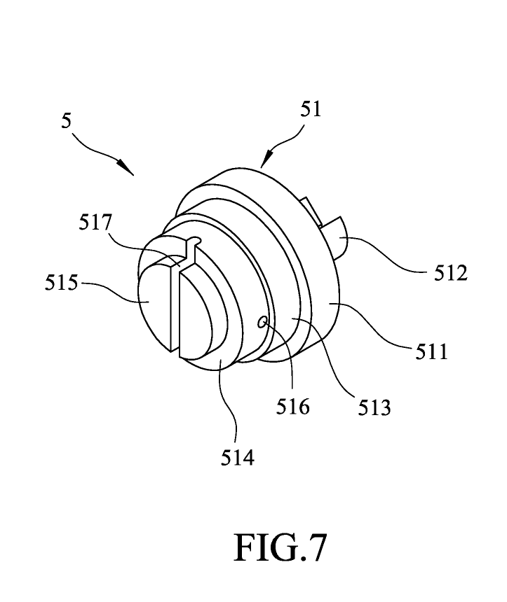

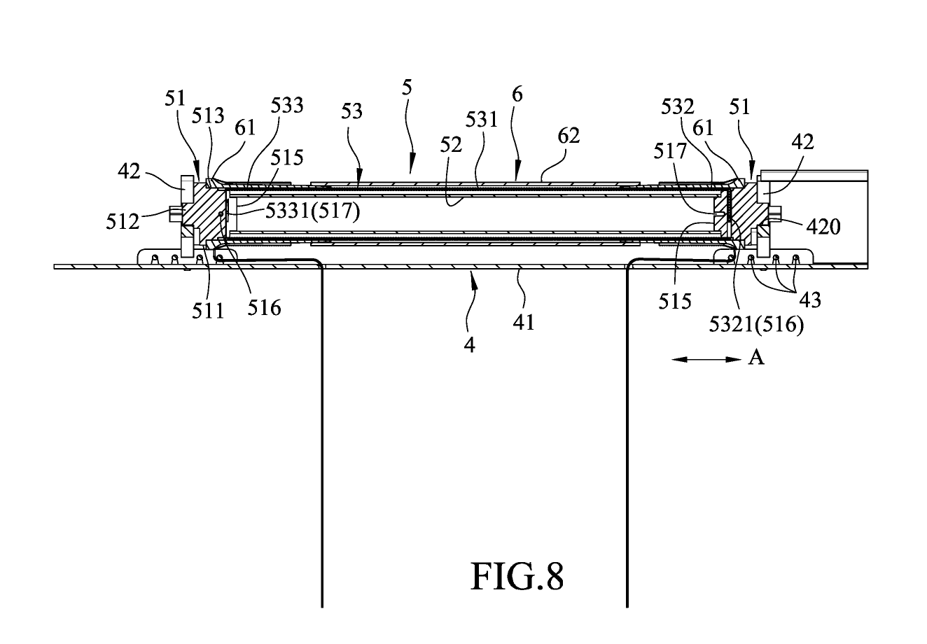

Referring to FIGS. 5 to 8, a winding device according to the first embodiment of the present disclosure is configured to be applied to a blind (not shown), and includes a frame unit 4, an inner pivot unit 5, and an outer pivot unit 6.

The frame unit 4 includes a frame 41 extending along an axial direction (A) and configured to be disposed on top of a blind body (not shown) of the blind, two pivot seats 42 disposed on the frame 41 and spaced apart from each other along the axial direction (A), and two friction adjustment rod units 43, each of which is disposed on a respective one of the pivot seats 42. Each pivot seat 42 includes an upper connecting portion 421 having a pivot hole 420 that extends along the axial direction (A), and a lower connecting portion 422 having two connecting arms 4221 extending along the axial direction (A) and spaced apart from each other in a direction transverse to the axial direction (A). In this embodiment, each friction adjustment rod unit 43 includes a plurality of friction adjustment rods 431 that are inserted between the connecting arms 4221 of the respective pivot seat 42, that are spaced apart from each other along the axial direction (A), and that extend in a direction transverse to the axial direction (A). It should be noted herein that, although a plurality of the friction adjustment rods 431 are exemplified in this embodiment, the number thereof can be adjusted according to actual requirement, and may be one only. Further, a distance between each two adjacent ones of the friction adjustment rods 431 along the axial direction (A) may be equal or different, and the heights of the friction adjustment rods 431 may be same or different. These factors are determined depending on the friction needed.

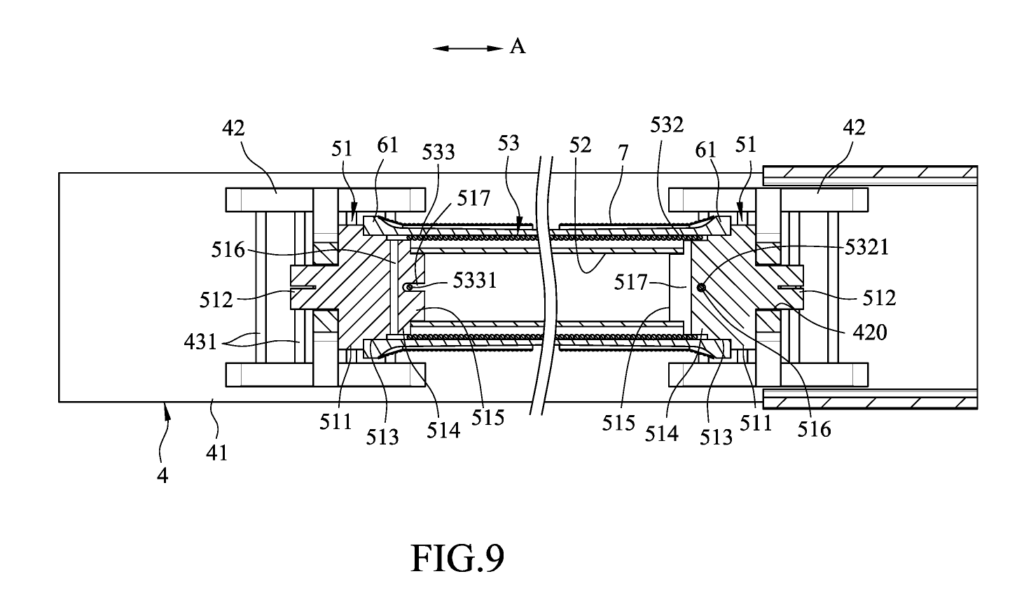

The inner pivot unit 5 includes two limiting members 51, an inner tube 52, and a spring member 53. The limiting members 51 are connected pivotally and respectively to the pivot seats 42. Each limiting member 51 has a circular body 511, an axle portion 512 protruding from one side of the circular body 511 along the axial direction (A) and inserted into the pivot hole 420 of the respective pivot seat 42, an extension portion 513 extending from the circular body 511 in a direction opposite to the axle portion 512 and having an outer diameter smaller than that of the circular body 511, a circular first protruding block 514 protruding from the extension portion 513 and having an outer diameter smaller than that of the extension portion 513, and a circular second protruding block 515 protruding from the first protruding block 514 and having an outer diameter smaller than that of the first protruding block 514. The first protruding block 514 has a radially extending limiting hole 516. The second protruding block 515 has a diametral notch 517. Two opposite ends of the inner tube 52 are respectively sleeved on the second protruding blocks 515 of the limiting members 51, as shown in FIG. 9.

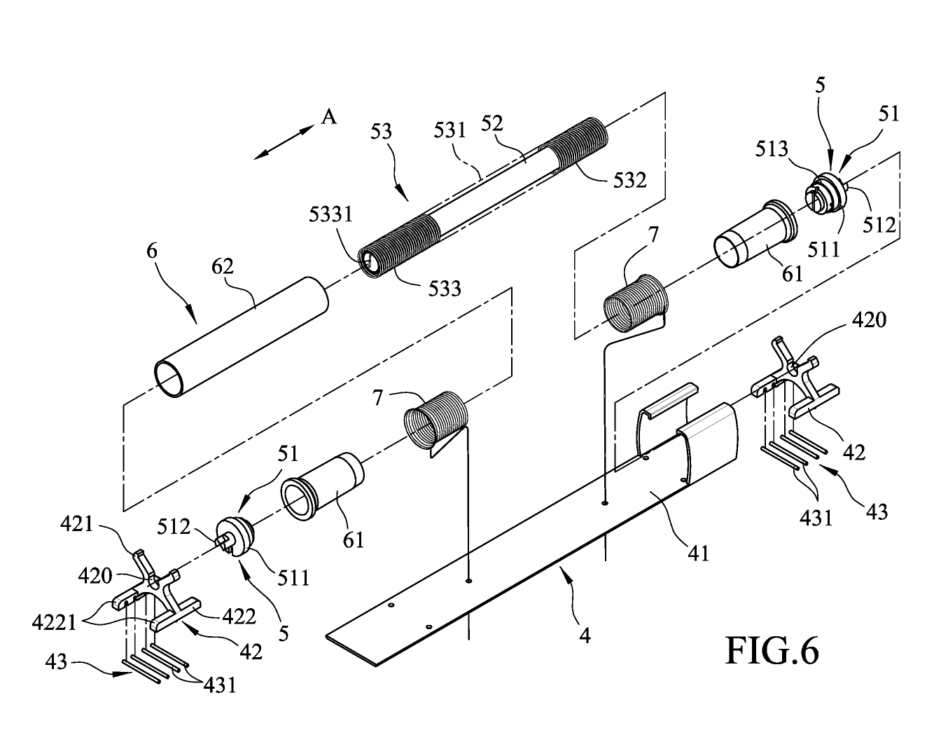

With reference to FIGS. 6, 7 and 9, the spring member 53 is a coiled spring having first and second end portions 532, 533 opposite to each other along the axial direction (A), and a central portion 531 between the first and second end portions 532, 533 and sleeved on the inner tube 52. The first end portion 532 is provided with a first insert arm 5321 inserted into the limiting hole 516 in one of the limiting members 51. The second end portion 533 is provided with a second insert arm 5331 engaged with the diametral notch 517 in the other one of the limiting members 51. It should be noted herein that the central portion 531 of the spring member 53 is shown in imaginary lines in FIG. 6 to illustrate how the spring member 53 is coiled around the inner tube 52. The inner tube 52 serves to limit an excessive slanting or bending of the spring member 53 during rotation thereof.

The outer pivot unit 6 includes an outer tube 62 sleeved on the central portion 531 of the spring member 53 and having two opposite ends, and two tubular sleeves 61 connected between one of the ends of the outer tube 62 and a corresponding one of the limiting members 51. Specifically, each tubular sleeve 61 has an inner end disposed between one of the ends of the outer tube 62 and a corresponding one of the first and second end portions 532, 533 of the spring member 53, and an outer end sleeved on the extension portion 513 of the corresponding limiting member 51. Each tubular sleeve 61 has an outer diameter tapering from the outer end toward the inner end thereof along the axial direction (A). One of the tubular sleeves 61 is fixed to one of the limiting members 51 using a screw-fastening or press-fit method so as to drive the one of the limiting members 51 to rotate synchronously. The other one of the tubular sleeves 61 is only coaxially sleeved on the other limiting member 51 and cannot drive the other limiting member 51 to rotate therealong. Furthermore, the distance between the limiting members 51 can be adjusted according to the lengths of the inner tube 52, the spring member 53 and the outer tube 62 so as to be beneficial for use in different sizes of blind bodies, so that it has a high multiusability.

In this embodiment, the tubular sleeves 61 shown in FIG. 5 are respectively used for releasably winding two lift cords 7 that extend through the blind body. In other embodiment, the tubular sleeves 61 may be used for winding directly the blind body. The friction adjustment rods 431 of each friction adjustment rod unit 43 are configured to permit each lift cord 7 to loop over prior to passing through the frame 41 for traveling along the blind body. When the blind body is pulled downward by a user, the lift cords 7 are unwound from the respective tubular sleeves 61, and drive the tubular sleeves 61 to rotate. At this time, one of the limiting members 51 is driven by one of the tubular sleeves 61 to rotate synchronously, while the other limiting member 51 is not driven by the other tubular sleeve 61 to rotate therealong. Since the two ends of the spring member 53 are connected to the respective limiting members 51, the first and second end portions 532, 533 of the spring member 53 are caused to twist and provide a restoring force to move the tubular sleeves 61 in an opposite direction. When the user releases the blind body, the weight of the blind body that acts on the lift cords 7 and the restoring force reach a balance, thereby achieving the effect of stepless adjustment of the blind body.

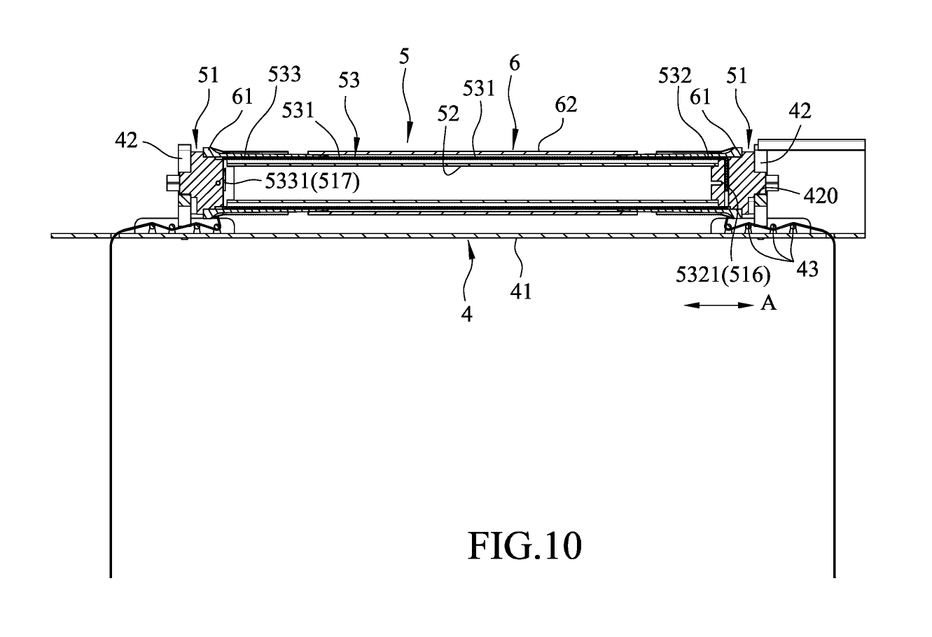

It should be noted herein that since the outer diameter of each tubular sleeve 61 tapers from the outer end toward the inner end thereof, when the tubular sleeves 61 wind the lift cords 7, each lift cord 7 will loop around the respective tubular sleeve 61 from the outer end toward the inner end thereof. As such, the lift cords are smoothly wound around the respective tubular sleeves 61 without entanglement. If the restoring force of the spring member 53 is greater than the weight of the blind body in some special circumstances, the friction between the friction adjustment rods 43 and the lift cords 7 can be used to assist in balancing the weight of the blind body, so that the needed counterweight can be reduced, thereby reducing the cost. Furthermore, by adjusting the number of the friction adjustment rods 43 looped over by each lift cord 7, and by changing the distances among the friction adjustment rods 43 as well as the heights thereof (the closer the distance, the smaller the angle, the larger the friction force), the magnitude of the friction force can be adjusted, so that a stepless adjustment can be made on the blind body for raising or lowering the same. Moreover, in this embodiment, exit points of the lift cords 7 are located between the pivot seats 42. However, in other embodiment, the exit points of the lift cords 7 may be adjusted according to the requirement, and may be located outside of the pivot seats 42, as shown in FIG. 10. Since there is no restriction on the location of the exit points of the lift cords 7, the sum of the lengths of the tubular sleeves 61 and the outer tube 62 does not need to be the same as the width of the blind body. Thus, the disposition space can be effectively saved.

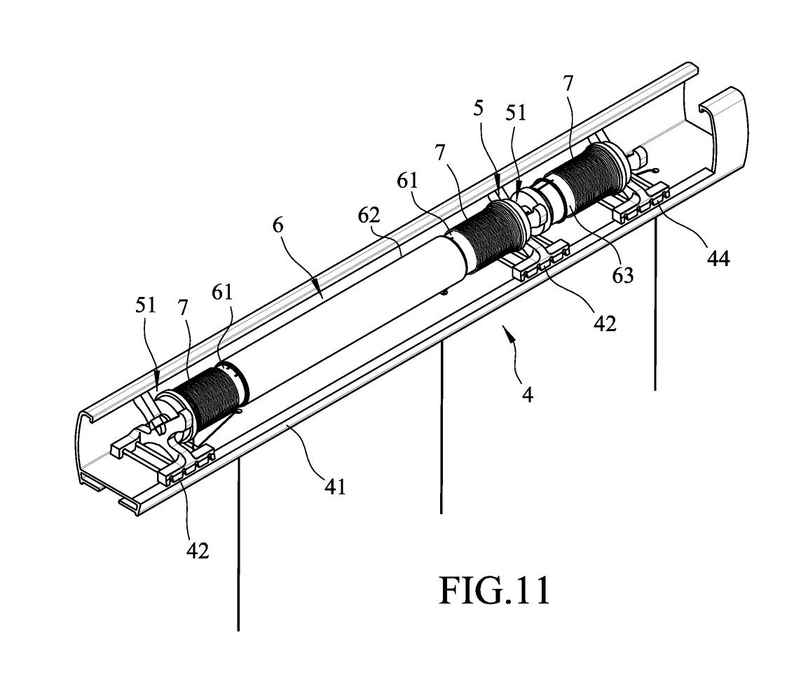

Referring to FIG. 11, the second embodiment of the winding device of this disclosure is shown to be identical to the first embodiment. However, in this embodiment, the frame unit 4 further includes a mounting seat 44 disposed on the frame 41 in proximity to the limiting member 51 which can be rotated by the respective tubular sleeve 61. The outer pivot unit 6 further includes a tubular connecting sleeve 63 having one end pivoted to the mounting seat 44, and the other end connected to the limiting member 51 which can be rotated by the respective tubular sleeve 61. The other end of the tubular connecting sleeve 63 may be connected to the limiting member 51 by using a screw or an adhesive, or may even be formed integrally as one piece with the limiting member 51. The tubular connecting sleeve 63 has a function similar to that of each tubular sleeve 61, and is used to releasably wind another one of the lift cords 7. When the blind body is pulled by the user and drives one of the limiting members 51 to rotate, the tubular connecting sleeve 63 connected to the one of the limiting members 51 is driven to rotate synchronously. The second embodiment uses three lift cords 7. However, in actual application, two of the winding devices of the first embodiment may be used to connect four lift cords 7, or one winding device of the first embodiment and one winding device of the second embodiment may be used to connect five lift cords 7. The applicability of this disclosure to different sizes or types of the blind bodies can be effectively increased.

In sum, the tubular sleeves 61 of this disclosure can cooperate with the lift cords 7 to connect with the blind body, but may be directly connected to the blind body of, for example, a Roman blind, a venetian blind and a shutter blind, so that use of the disclosure is extensive. Further, the lift cords 7 can be dragged to the tubular sleeves 61, so that there is no need to align the tubular sleeves 61 with the exit points of the lift cords 7. Moreover, the spring member 53 is more durable than the conventional spring members. Therefore, the object of this disclosure can be realized.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A winding device for a blind, comprising:
a frame unit including a frame extending along an axial direction, and two pivot seats disposed on said frame and spaced apart from each other along the axial direction;
an inner pivot unit including two limiting members connected pivotally and respectively to said pivot seats, an inner tube connected between said limiting members, and a spring member sleeved on said inner tube and having first and second end portions opposite to each other along the axial direction and respectively connected to said limiting members; and
an outer pivot unit including an outer tube sleeved on said spring member and having two opposite ends, and two tubular sleeves each of which is connected between one of said ends of said outer tube and a corresponding one of said limiting members, said tubular sleeves being configured to be driven by a blind body of the blind;
wherein, when the blind body is moved in an up-down direction, said tubular sleeves are driven by the blind body to rotate, and one of said tubular sleeves drives one of said limiting members to rotate synchronously, but the other one of said tubular sleeves cannot drive the other one of said limiting members to rotate therealong, such that said first and second end portions of said spring member are twisted to provide a resilient restoring force for balancing and positioning the blind body.

2. The winding device as claimed in claim 1, wherein said one of said tubular sleeves is fixed to said one of said limiting members so as to drive said one of said limiting members to rotate synchronously, but said other one of said tubular sleeves is coaxially sleeved on said other one of said limiting members and cannot drive said other one of said limiting members to rotate therealong.

3. The winding device as claimed in claim 2, wherein each of said pivot seats is formed with a pivot hole extending along the axial direction, and each of said limiting members has a circular body, an axle portion protruding from one side of said circular body along the axial direction and inserted into said pivot hole of a respective one of said pivot seats, an extension portion extending from said circular body in a direction opposite to said axle portion, a first protruding block protruding from said extension portion, and a second protruding block protruding from said first protruding block, each of said ends of each of said tubular sleeves being sleeved on said extension portion of the corresponding one of said limiting members, said inner tube having two opposite ends each of which is sleeved on said second protruding blocks of the corresponding one of said limiting members.

4. The winding device as claimed in claim 3, wherein said first protruding block of each of said limiting members is circular and has a radially extending limiting hole, said second protruding block having a diametral notch, said spring member being a coiled spring having said first and second end portions, and a central portion between said first and second opposite end portions and sleeved on said inner tube, said first end portion being provided with a first insert arm inserted into said limiting hole in one of said limiting members, said second end portion being provided with a second insert arm engaged with said diametral notch in the other one of said limiting members.

5. The winding device as claimed in claim 4, wherein each of said tubular sleeves has an outer diameter tapering from an outer end toward an inner end thereof along the axial direction.

6. The winding device as claimed in claim 5, wherein a plurality of lift cords extend through the blind body, and wherein each of said tubular sleeves is configured to releasably wind a corresponding one of the lift cords thereon, said frame unit further including a plurality of friction adjustment rod units, each of which is disposed on a corresponding one of said pivot seats, each of said pivot seats including an upper connecting portion having said pivot hole, and a lower connecting portion having two connecting arms extending along the axial direction and spaced apart from each other in a direction transverse to the axial direction, each of said friction adjustment rod units including a plurality of friction adjustment rods disposed between said connecting arms of the corresponding one of said pivot seats and spaced apart from each other along the axial direction, said friction adjustment rods being configured to permit the lift cords to loop over.

7. The winding device as claimed in claim 6, wherein each of said friction adjustment rods extends in a direction transverse to the axial direction.

8. The winding device as claimed in claim 6, wherein said frame unit further includes a mounting seat disposed on said frame in proximity to said one of said limiting members, said outer pivot unit further including a tubular connecting sleeve having one end pivoted to said mounting seat, and the other end connected to said one of said limiting members, said tubular connecting sleeve being configured to wind another one of the lift cords thereon and being driven by said one of said limiting members to rotate synchronously with said tubular sleeves.
